(19) United States
(12) Patent Application Publication
(10) Pub. No.: US 2022/0229192 A1
(43) Pub. Date: Jul. 21, 2022

(54) OPTICAL RANGING DEVICE AND CONTROL METHOD FOR OPTICAL RANGING DEVICE

(71) Applicant: DENSO CORPORATION, Kariya-city (JP)

(72) Inventor: Fumiaki MIZUNO, Kariya-city (JP)

(21) Appl. No.: 17/658,394

(22) Filed: Apr. 7, 2022

Related U.S. Application Data
(63) Continuation of application No. PCT/JP2020/034733, filed on Sep. 14, 2020.

(30) Foreign Application Priority Data
Oct. 11, 2019 (JP) 2019-187231

(51) Int. Cl. G01S 17/931; G01S 7/481

(52) U.S. Cl. CPC G01S 17/931; G01S 7/4817

(57) ABSTRACT

An optical ranging device installed in a vehicle includes: a light emitter that emits irradiation light; a scanner that scans a predefined scan region with the irradiation light; a light receiver that, in response to the scan with the irradiation light, receives light including reflected light of the irradiation light from the scan region and outputs an electrical signal corresponding to the reception state of the reflected light; and a measurer that measures the distance to an object within at least the scan region based on the signal output from the light receiver. The optical ranging device changes the state of scanning by the scanner with the irradiation light in accordance with the traveling situation of the vehicle.

### CROSS-REFERENCE TO RELATED APPLICATION

This application is the U.S. bypass application of International Application No. PCT/JP2020/034733 filed on Sep. 14, 2020 which designated the U.S. and claims priority to Japanese Patent Application No. 2019-187231 filed on Oct. 11, 2019, the contents of both of which are incorporated herein by reference.

### TECHNICAL FIELD

The present disclosure relates to an optical ranging device.

### BACKGROUND

A known optical ranging device is a radar device including a scan unit that scans a predetermined scan region with a laser beam. The radar device searches for an object within the scan region based on the laser beam reflected from the scan region (e.g., JP H07-325154 A, WO2015/122095).

### SUMMARY

An aspect of the present disclosure provides an optical ranging device to be installed on a vehicle. The optical ranging device includes: a light emitter that emits irradiation light; a scanner that scans a predefined scan region with the irradiation light; a light receiver that, in response to the scan with the irradiation light, receives light including the reflected light of the irradiation light from the scan region and outputs an electrical signal corresponding to the reception state of the reflected light; and a measurer that measures the distance to an object within at least the scan region based on the signal output from the light receiver. The scanner performs scanning with the irradiation light in a reference scan direction indicating a predetermined direction of scanning with the irradiation light. When the scan region is defined lateral to the vehicle, the reference scan direction on the right and the reference scan direction on the left are opposite to each other, and the scanner switches between the reference scan direction and a reverse scan direction opposite to the reference scan direction in accordance with a speed difference between a target and the vehicle derived from traveling information and traveling environment information about the vehicle, and performs scanning with the irradiation light.

Another aspect of the present disclosure provides a control method for an optical ranging device installed in a vehicle and configured to: scan a predefined scan region with irradiation light; in response to the scan with the irradiation light, receive light including the reflected light of the irradiation light from the scan region; and measure the distance to an object within at least the scan region based on an electrical signal corresponding to the reception state of the reflected light. The control method performs scanning with the irradiation light in a reference scan direction indicating a predetermined direction of scanning with the irradiation light. When the scan region is defined lateral to the vehicle, the reference scan direction on the right and the reference scan direction on the left are opposite to each other, and the method comprises switching between the reference scan direction and a reverse scan direction opposite to the reference scan direction in accordance with a speed difference between a target and the vehicle derived from traveling information and traveling environment information about the vehicle, and performing scanning with the irradiation light.

### BRIEF DESCRIPTION OF THE DRAWINGS

The above features of the present disclosure will be made clearer by the following detailed description, given referring to the appended drawings. In the accompanying drawings:

FIG. 1 is a schematic view of a vehicle equipped with optical ranging devices according to an embodiment of the present disclosure;

FIG. 2 is a schematic configuration diagram of an optical ranging device according to the embodiment;

FIG. 3 is an image illustrating a basic scanning state of the optical ranging devices according to the embodiment;

FIG. 4 is a timing chart showing an example of the scanning state of the optical ranging devices in FIG. 3;

FIG. 5 is a diagram describing the differences in the appearances of objects of interest from the optical ranging devices in FIG. 3;

FIG. 6 is an image illustrating an example scanning state of optical ranging devices for a first traveling situation according to a first embodiment;

FIG. 7 is a timing chart showing an example of the scanning state of the optical ranging devices in FIG. 6;

FIG. 8 is an image illustrating an example scanning state of the optical ranging devices for a second traveling situation according to the first embodiment;

FIG. 9 is a timing chart showing an example of the scanning state of the optical ranging devices in FIG. 8;

FIG. 10 is an image illustrating an example scanning state of the optical ranging devices for a third traveling situation according to the first embodiment;

FIG. 11 is a timing chart showing an example of the scanning state of the optical ranging devices in FIG. 10;

FIG. 12 is an image illustrating an example scanning state of the optical ranging devices for a fifth traveling situation according to the first embodiment;

FIG. 13 is a timing chart showing an example of the scanning state of the optical ranging devices in FIG. 12; and

FIG. 14 is an image illustrating an example scanning state of optical ranging devices for a sixth traveling situation according to a second embodiment.

### DETAILED DESCRIPTION OF THE PREFERRED EMBODIMENTS

An optical ranging device including a scan unit typically has a preset scan direction. Thus, for an optical ranging device installed on a vehicle, the measurement performance varies depending on the traveling situation of the vehicle. There is a desire for a technique that achieves stable measurement performance even when the traveling situation of the vehicle varies.

An aspect of the present disclosure provides an optical ranging device to be installed on a vehicle. The optical ranging device includes: a light emitter that emits irradiation light; a scanner that scans a predefined scan region with the irradiation light; a light receiver that, in response to the scan with the irradiation light, receives light including the reflected light of the irradiation light from the scan region and outputs an electrical signal corresponding to the reception state of the reflected light; and a measurer that measures the distance to an object within at least the scan region based on the signal output from the light receiver. The scanner performs scanning with the irradiation light in a reference scan direction indicating a predetermined direction of scanning with the irradiation light. When the scan region is defined lateral to the vehicle, the reference scan direction on the right and the reference scan direction on the left are opposite to each other, and the scanner switches between the reference scan direction and a reverse scan direction opposite to the reference scan direction in accordance with a speed difference between a target and the vehicle derived from traveling information and traveling environment information about the vehicle, and performs scanning with the irradiation light.

The optical ranging device can change the state of scanning with irradiation light in accordance with the traveling situation of the vehicle, and thus reduce variations in measurement performance that occur depending on traveling situations of the vehicle, enabling stable measurement performance to be achieved even when the traveling situation of the vehicle changes.

Another aspect of the present disclosure provides a control method for an optical ranging device installed in a vehicle and configured to: scan a predefined scan region with irradiation light; in response to the scan with the irradiation light, receive light including the reflected light of the irradiation light from the scan region; and measure the distance to an object within at least the scan region based on an electrical signal corresponding to the reception state of the reflected light. The control method performs scanning with the irradiation light in a reference scan direction indicating a predetermined direction of scanning with the irradiation light. When the scan region is defined lateral to the vehicle, the reference scan direction on the right and the reference scan direction on the left are opposite to each other, and the method comprises switching between the reference scan direction and a reverse scan direction opposite to the reference scan direction in accordance with a speed difference between a target and the vehicle derived from traveling information and traveling environment information about the vehicle, and performing scanning with the irradiation light.

The control method for the optical ranging device can change the state of scanning with irradiation light in accordance with the traveling situation of the vehicle, and thus reduce variations in measurement performance that occur depending on traveling situations of the vehicle, enabling stable measurement performance to be achieved even when the traveling situation of the vehicle changes.

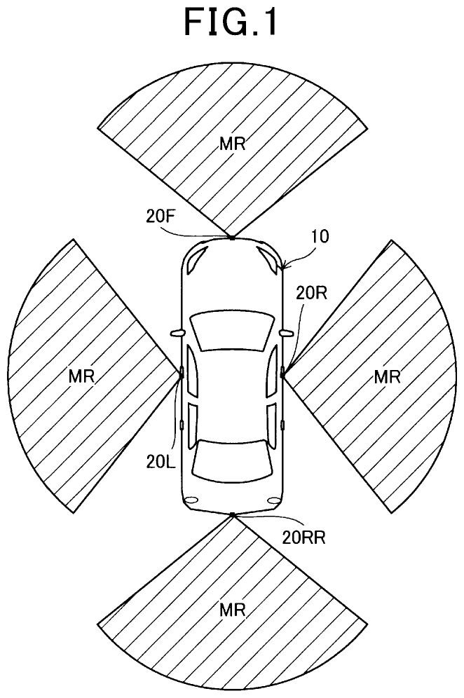

An optical ranging device is a device that optically measures the distance to an object to be measured. As shown in FIG. 1, an optical ranging device 20 according to an embodiment of the present disclosure is installed in a vehicle 10 and used as a device (or a radar) that measures the spatial location of an object within the scan region, including the distance to the object. FIG. 1 shows an example in which four optical ranging devices 20 are installed for scan regions defined on the front, the rear, the left, and the right of the vehicle 10. The optical ranging devices 20 have their own scan regions MR each represented by a hatched sector. When the four optical ranging devices 20 are distinguished from each other, the front, the rear, the left, and the right optical ranging devices are respectively denoted by reference numerals 20F, 20RR, 20L, and 20R in accordance with the directions of the individual scan regions.

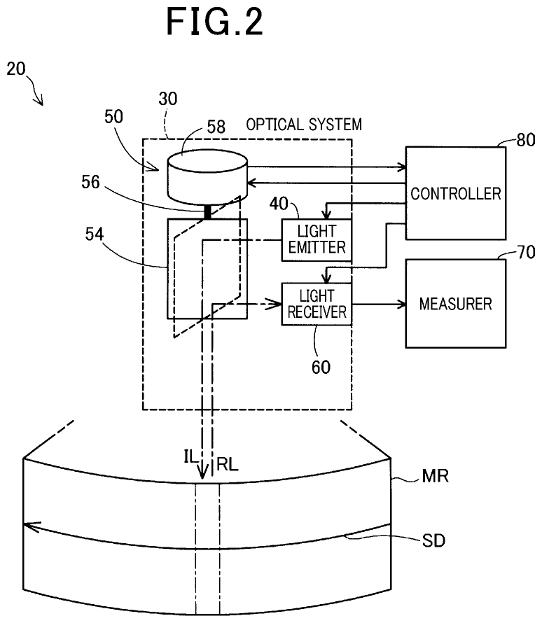

Each optical ranging device 20, as shown in FIG. 2, includes an optical system 30 that emits irradiation light IL for measurement and receives light including reflected light RL from an object to be measured (hereinafter also referred to as a target), a measurer 70 that uses signals from the optical system 30 to detect any target and measure the distance to the target (also referred to as ranging), and a controller 80 that controls the optical system 30. The optical system 30 includes a light emitter 40 that emits a laser beam as irradiation light, a scanner 50 that scans a measurement scan region MR with the laser beam in a scan direction SD, and a light receiver 60 that receives light including the reflected light from the region irradiated with the laser beam (the region indicated in the figure by dash-dot lines).

The scanner 50 includes a reflector 54 that reflects the laser beam emitted from the light emitter 40, a rotational shaft 56 fixed along the central axis of the reflector 54, and a rotary solenoid 58 that rotates the rotational shaft 56. The rotary solenoid 58 is controlled by the controller 80 to alternate forward rotation and reverse rotation within a predetermined angular region. As a result, the rotation of the reflector 54 about the rotational shaft 56 allows scanning with the irradiation light IL in the scan direction SD indicating the direction of the scanning from one horizontal end to the other horizontal end of the scan region MR. The actuator that rotates the rotational shaft 56 is not limited to the rotary solenoid 58, and various electric motors such as a brushless motor may be used. The actuator may be any device capable of alternating forward rotation and reverse rotation within a predetermined angular region.

The laser beam emitted from the optical ranging device 20 is diffusely reflected by the surface of any object such as a human or a car, and partially returns to the reflector 54 of the scanner 50 as reflected light RL. The reflected light RL is reflected by the reflector 54 together with other ambient light and received by the light receiver 60.

The light receiver 60 includes multiple light receiving elements arranged two-dimensionally on the light receiving surface for receiving the reflected light, and each light receiving element outputs a signal in accordance with the reception state of the reflected light.

The measurer 70 can detect any object within the scan region MR and computationally measure the distance to the object based on the time from when the light emitter 40 emits the laser beam to when the light receiver 60 receives the reflected light.

The optical ranging device 20 may have any scan direction and any scanning rate determined by the rotary solenoid 58 controlling the rotational direction and the rotational speed of the rotational shaft 56.

### A. First Embodiment

Of the optical ranging devices 20 installed in the vehicle 10 shown in FIG. 1, the lateral optical ranging devices, or the left optical ranging device 20L and the right optical ranging device 20R, will now be described as optical ranging devices according to a first embodiment.

The scan directions indicating the directions of scanning by the left optical ranging device 20L and the right optical ranging device 20R, which have scan regions lateral to the vehicle 10, are typically each set as one scanning direction from either the left end or the right end of the scan region MR to the other end (refer to FIG. 1). When the scan direction is set as one direction, traveling situations of the vehicle 10 affect acquired data, as described later. The traveling situations refer to a variety of situations regarding vehicle traveling, such as various traveling states and environments including the traffic segmentation, the type of the road, the kind of driving lane, the relationship with other vehicles, and the traveling conditions.

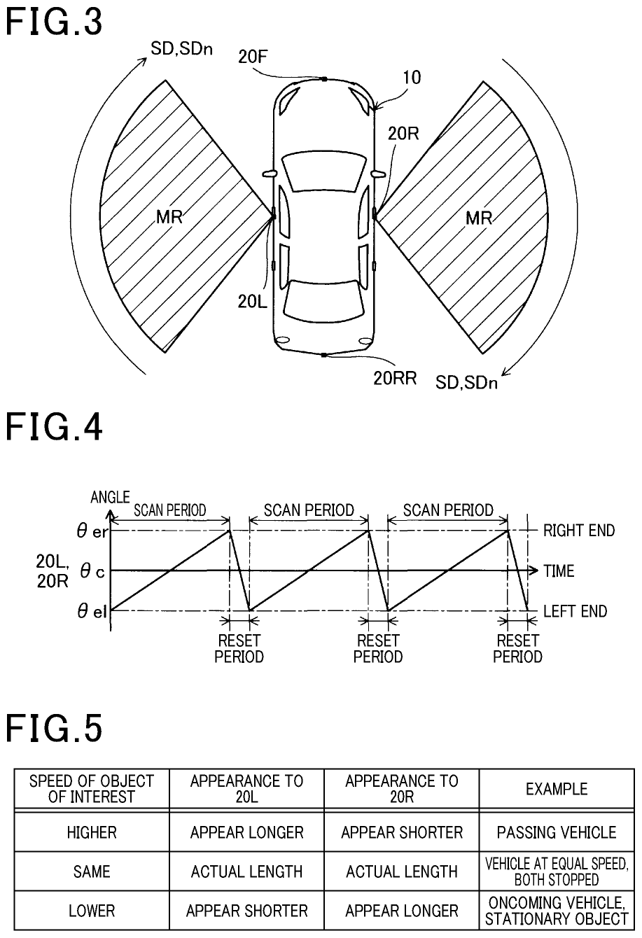

It is assumed that, as shown in FIGS. 3 and 4, the lateral optical ranging devices 20L and 20R have a scan direction SD set usually as a direction of scanning from the left end to the right end of the scan region MR, and the left optical ranging device 20L scans the range from the rear to the front of the vehicle 10, while the right optical ranging device 20R scans the range from the front to the rear of the vehicle 10. Hereinafter, this basic scan direction SD is also referred to as a normal scan direction SDn. In the timing chart of FIG. 4, when scanning is directed to the left end of the scan region MR, the rotation angle of the reflector 54 is a left end angle θel. When scanning is directed to the right end, the rotation angle of the reflector 54 is a right end angle θer. When scanning is directed to the central position between the left end and the right end, the rotation angle of the reflector 54 is a reference angle θc. FIG. 4 also shows scan periods during which scanning is performed in a set scan direction, and reset periods during which the rotation angle of the reflector 54 is reset from the angle at the end of scanning to the angle at the start of scanning.

As shown in FIG. 5, the relationship between the speeds of the vehicle 10 (hereinafter also referred to as the user's vehicle) and an object of interest within the scan region MR (hereinafter also referred to as an object of interest) affects the appearance of the object of interest in an image represented by the data acquired by scanning. For example, when the user's vehicle and another vehicle are moving at the same speed or the user's vehicle and another vehicle are stopped next to each other, or when the user's vehicle and an object of interest are at the same speed (the middle row of the figure), the object of interest appears to have the same length as the actual length to the left optical ranging device 20L and the right optical ranging device 20R. In contrast, when a vehicle is passing or pulling ahead of the user's vehicle, or when an object of interest is higher in velocity than the user's vehicle (the upper row of the figure), the object of interest appears longer than the actual length to the left optical ranging device 20L, while the object of interest appears shorter than the actual length to the right optical ranging device 20R. When a vehicle is coming in the direction opposite to the user's vehicle or the user's vehicle is passing by a stationary object, or when an object of interest is lower in velocity than the user's vehicle (the lower row of the figure), the object of interest appears shorter than the actual length to the left optical ranging device 20L, while the object of interest appears longer than the actual length to the right optical ranging device 20R. The difference in appearance becomes more significant as the difference between the speeds of the user's vehicle and the object of interest widens. Although not shown, when the scan direction SD is a direction of scanning from the right end to the left end, which is opposite to the direction of scanning from the left end to the right end, the difference in the appearance of an object of interest is the reverse of the difference in the appearance shown in FIG. 5.

Accordingly, the lateral optical ranging devices 20L and 20R acquire different data in different traveling situations of the vehicle 10, which may affect the measurement performance such as the efficiency of detecting an object of interest and the ranging performance.

Thus, in the first embodiment, the optical ranging devices 20L and 20R improve the accuracy in measuring an object of interest by changing the scanning state, or specifically, the scan direction and the scanning rate, in accordance with the traveling situation of the vehicle 10, that is, various situations associated with vehicle traveling such as various traveling states and traveling environments. The following describes some specific examples in which the scanning state is changed in accordance with the traveling situation.

### (First Traveling Situation)

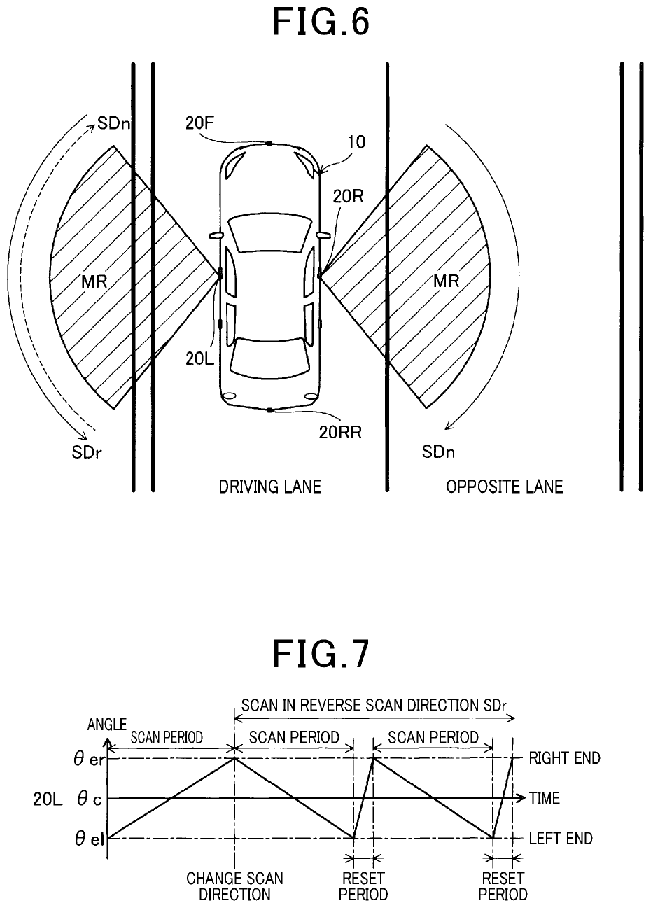

In a first traveling situation in which the vehicle travels along a two-lane road, it may be preferable to, for example, watch for a stationary object by the left side of the road and a bicycle or a pedestrian moving along the left side of the road (hereinafter also referred to as a stationary object by the left side of the road) at a speed lower than the speed of the user's vehicle (hereinafter also referred to as the user's speed). Thus, when the first traveling situation occurs, in order to accurately measure a stationary object by the left side of the road as an object of interest, it is preferable to, at the end of the current scan, change the scan direction of the left optical ranging device 20L to the direction opposite to the normal scan direction SDn, or in other words, a reverse scan direction SDr from the right end to the left end of the scan region MR, as shown in FIGS. 6 and 7. The scan direction can be changed by simply redirecting the scanning, and thus the changing is quicker than resetting the scanning to the starting end. The scan direction of the right optical ranging device 20R may continue to be the normal scan direction SDn.

With the scan direction of the left optical ranging device 20L still being the normal scan direction SDn, an object of interest such as a stationary object by the left side of the road would appear shorter than the actual length (see FIG. 4), probably reducing the measurement performance for the object of interest. In contrast, changing the scan direction of the left optical ranging device 20L to the reverse scan direction SDr prevents a stationary object by the left side of the road from appearing shorter than the actual length, enabling the object of interest to be measured with high accuracy as for the right optical ranging device 20R.

### (Second Traveling Situation)

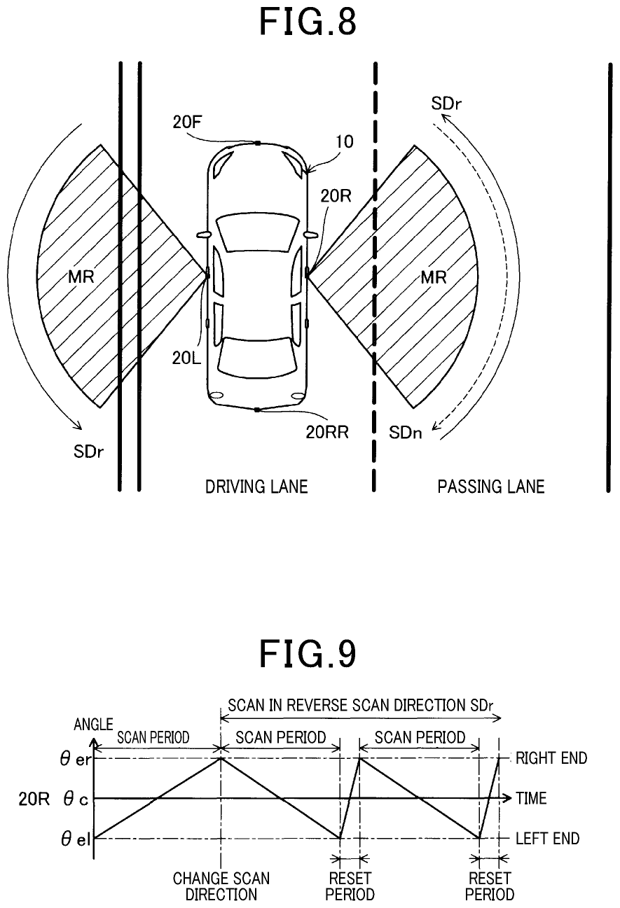

In a second traveling situation in which the vehicle travels along a driving lane of a four-lane road including driving lanes and passing lanes, it may be preferable to, for example, watch for a vehicle traveling in the passing lane and running past at a speed higher than the user's speed. Thus, when the second traveling situation occurs, in order to accurately measure a passing vehicle as an object of interest, it is preferable to, at the end of the current scan, change the scan direction of the right optical ranging device 20R from the normal scan direction SDn to the reverse scan direction SDr as for the left optical ranging device 20L, as shown in FIGS. 8 and 9.

With the scan direction of the right optical ranging device 20R still being the normal scan direction SDn, an object of interest such as a passing vehicle traveling in the passing lane would appear shorter than the actual length (see FIG. 4), probably reducing the measurement performance for the object of interest. In contrast, changing the scan direction of the right optical ranging device 20R to the reverse scan direction SDr prevents an object of interest such as a passing vehicle traveling in the passing lane from appearing shorter than the actual length, enabling the object of interest to be measured with high accuracy.

### (Third Traveling Situation)

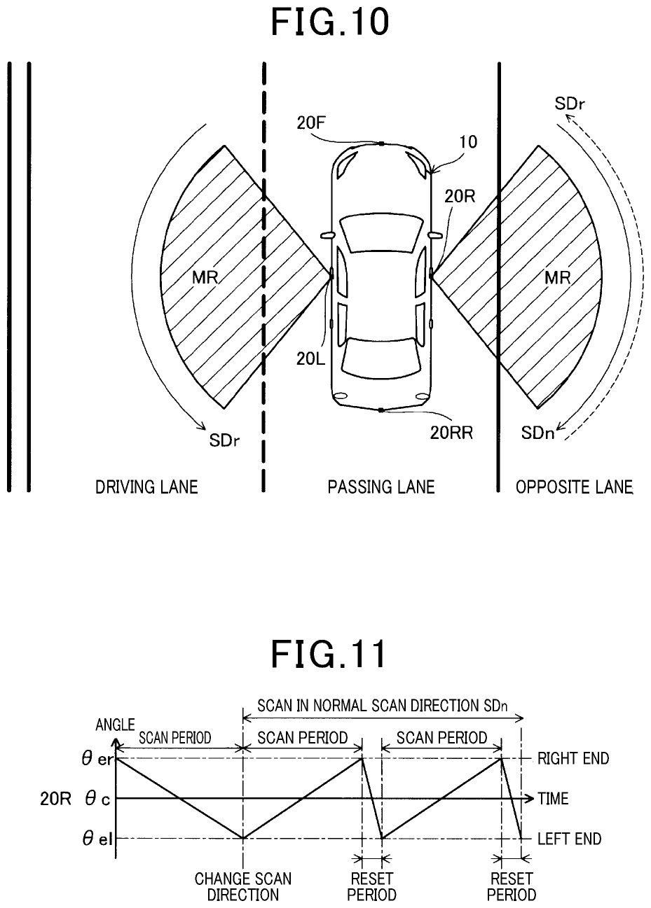

When the user's vehicle changes lanes to shift from the second traveling situation in which the user's vehicle travels in the driving lane to a third traveling situation in which the user's vehicle travels in the passing lane, it may be preferable to watch for a vehicle traveling in the opposite lane. Thus, when the third traveling situation occurs, in order to accurately measure a vehicle traveling in the opposite lane as an object of interest, it is preferable to, at the end of the current scan, return the scan direction of the right optical ranging device 20R from the reverse scan direction SDr in the second traveling situation to the normal scan direction SDn, as shown in FIGS. 10 and 11.

Since vehicles in the driving lane are traveling probably more slowly than the user's vehicle traveling in the passing lane, the left optical ranging device 20L may not change the scan direction but continue the reverse scan direction SDr so as to accurately measure stopped vehicles and vehicles traveling in the driving lane more slowly than the user's vehicle as objects of interest.

### (Fourth Traveling Situation)

When traveling in the passing lane as in the third traveling situation, the user's vehicle may encounter a fourth traveling situation in which a passing vehicle travels in the driving lane. In this situation, in order to accurately measure the passing vehicle traveling in the driving lane as an object of interest, the left optical ranging device 20L preferably, at the end of the current scan, returns the scan direction from the reverse scan direction SDr to the normal scan direction SDn as for the right optical ranging device 20R (see FIGS. 10 and 11).

### (Fifth Traveling Situation)

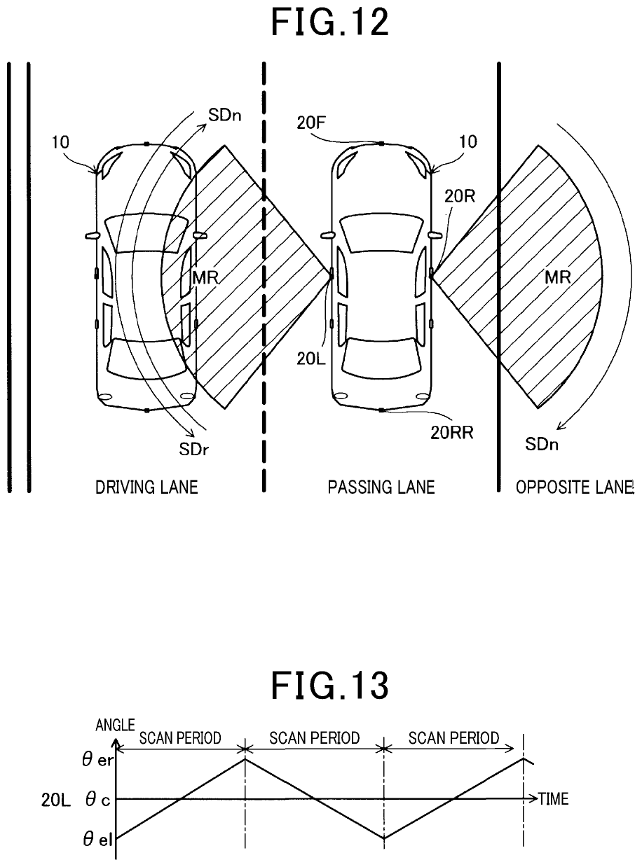

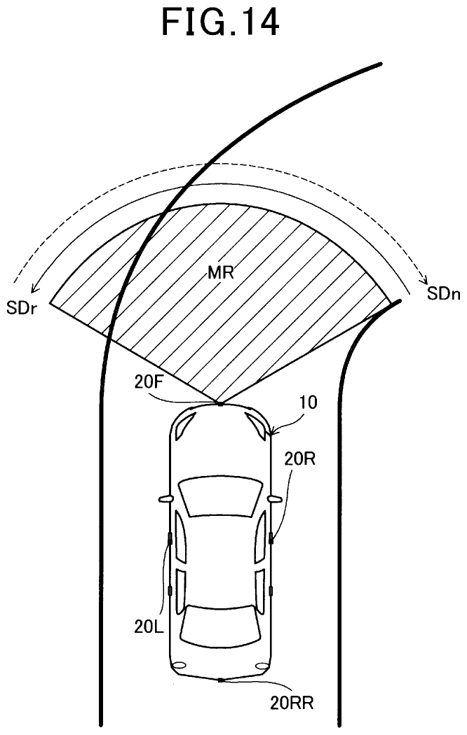

When traveling in the passing lane as in the third traveling situation, the user's vehicle may encounter a fifth traveling situation in which a vehicle travels in the driving lane alongside the user's vehicle at about the same speed. In this situation, in order to accurately measure the distance to the parallel traveling vehicle as an object of interest, the left optical ranging device 20L preferably, at the end of the current scan, alternates the scan direction between the normal scan direction SDn and the reverse scan direction SDr, as shown in FIGS. 12 and 13.

An object of interest such as a vehicle traveling in the driving lane alongside the user's vehicle at about the same speed appears to have the actual length irrespective of the scan direction (see FIG. 4). Thus, reciprocating scanning performed while alternating the normal scan direction SDn and the reverse scan direction SDr causes no difference in appearance. Thus, when reciprocating scanning is performed while alternating the scan direction between the normal scan direction SDn and the reverse scan direction SDr as described above, the scanning is more efficient than scanning in any one scan direction.

The above traveling situations can be determined based on, for example, traveling information indicating the traveling state of the vehicle 10, analysis information about an image taken by a camera (not shown) installed on the vehicle 10, traveling environment information such as traffic information obtained from a navigation system (not shown) installed in the vehicle 10, and measurement information from each optical ranging device 20. The optical ranging devices 20L and 20R installed in the vehicle 10 can control the changing of the scan direction in accordance with the traveling situation determination results.

As described above, the optical ranging devices 20L and 20R according to the first embodiment improve the accuracy in measuring an object of interest by changing the scanning state in accordance with the traveling situation of the vehicle 10, that is, various situations associated with vehicle traveling such as various traveling states and traveling environments. This reduces variations in measurement performance that occur depending on traveling situations of the vehicle, enabling stable measurement performance to be achieved even when the traveling situation of the vehicle changes.

### B. Second Embodiment

The optical ranging device 20F installed on the front of the vehicle 10 in FIG. 1 and used to scan a forward range of the vehicle 10 will now be described as an optical ranging device according to a second embodiment. In the description that follows, the direction of scanning by the front optical ranging device 20F is also set usually as the normal scan direction SDn indicating a direction of scanning from the left end to the right end of the scan region MR, as for the lateral optical ranging devices 20L and 20R.

For example, when the vehicle 10 turns right, it is easy to detect a moving object such as a human or a vehicle coming from the left into the road. However, it is difficult to detect a moving object coming from the right. Thus, in a sixth traveling situation in which the vehicle 10 turns right, it is preferable to, at the end of the current scan, change the scan direction of the front optical ranging device 20F from the normal scan direction SDn in which scanning is performed from the left end to the right end of the scan region MR (see FIG. 1), to the reverse scan direction SDr in which scanning is performed from the right end to the left end of the scan region MR, as shown in FIG. 14. This scanning can facilitate detection of a moving object coming from the right when the vehicle is turning right.

When the vehicle 10 turns left, it is difficult to detect a moving object coming from the left in contrast to turning right, and thus the scan direction of the optical ranging device 20F may continue to be the normal scan direction SDn.

The turning direction of the vehicle 10 can be determined based on, for example, the steering state. The front optical ranging device 20F can control the changing of the scan direction in accordance with the traveling situation determination results. Furthermore, as in the first embodiment, the turning direction can also be determined based on traveling information about the vehicle 10, analysis information about an image, traveling environment information such as traffic information, and measurement information from each optical ranging device 20.

As described above, the optical ranging device 20F according to the second embodiment also improves the accuracy in measuring an object of interest by changing the scanning state in accordance with the traveling situation of the vehicle 10. This reduces variations in measurement performance that occur depending on traveling situations of the vehicle, enabling stable measurement performance to be achieved even when the traveling situation of the vehicle changes.

### C. Other Embodiments

(1) The changing of the scan direction in accordance with the traveling situation described in the above embodiments is illustrative and not limited to the illustrated example. The scan direction may be changed to a preset scan direction so as to achieve scanning appropriate to the traveling situation.

(2) In the above embodiments, the changing of the scan direction in accordance with the traveling situation has been described as an example in order to facilitate the description of changing the scanning state in accordance with the traveling situation. However, the changing is not limited to this example. The scanning rate may be changed in accordance with the traveling situation. In other cases, the scan direction and the scanning rate may also be changed.

(3) Although the front and the lateral optical ranging devices have been described in the above embodiments, the present disclosure is also applicable to the rear optical ranging device.

(4) In the above embodiments, the optical ranging devices described as an example each scan a given angular region with irradiation light by the actuator rotating the reflector. However, the optical ranging devices are not limited to the example. The optical ranging devices may be liquid crystal scanners, optical phased array (OPA) lidar systems, or other various optical ranging devices that can scan a predetermined angular region while alternating forward rotation and reverse rotation. In other words, each optical ranging device according to the present disclosure may be any optical ranging device that changes the scanning state to a preset scanning state so as to perform scanning appropriate to the traveling situation based on the scan region scanned by the optical ranging device with respect to the vehicle equipped with the device. These optical ranging devices can change the state of scanning with irradiation light in accordance with the traveling situation of the vehicle, and thus reduce variations in measurement performance that occur depending on traveling situations of the vehicle, enabling stable measurement performance to be achieved even when the traveling situation of the vehicle changes.

The controller and the control method described in the present disclosure may be implemented by a special purpose computer including memory and a processor programmed to execute one or more functions embodied by computer programs. Alternatively, the controller and the control method described in the present disclosure may be implemented by a special purpose computer including a processor formed of at least one dedicated hardware logic circuit. Alternatively, the controller and the control method described in the present disclosure may be implemented by at least one dedicated computer including a combination of memory and a processor programmed to execute one or more functions and a processor formed of at least one hardware logic circuit. The computer programs may be stored in a non-transitory, tangible computer readable storage medium as instructions executed by a computer.

The present disclosure is not limited to the above embodiments but may be implemented in a variety of ways without departing from the spirit and scope thereof. For example, the technical features in each embodiment corresponding to the technical features in the aspects described in the Summary section may be replaced or combined as appropriate so as to solve some or all of the above-described problems or achieve some or all of the above-described effects. Unless described herein as being necessary, the technical features may be deleted as appropriate.

What is claimed is:

1. An optical ranging device installed in a vehicle, the device comprising:
a light emitter configured to emit irradiation light;
a scanner configured to scan a predefined scan region with the irradiation light;
a light receiver configured to, in response to the scan with the irradiation light, receive light including reflected light of the irradiation light from the scan region, and output an electrical signal corresponding to a reception state of the reflected light; and
a measurer configured to measure a distance to an object within at least the scan region based on the signal output from the light receiver,
wherein
the scanner performs scanning with the irradiation light in a reference scan direction indicating a predetermined direction of scanning with the irradiation light,
when the scan region is defined lateral to the vehicle, the reference scan direction on the right and the reference scan direction on the left are opposite to each other, and
the scanner switches between the reference scan direction and a reverse scan direction opposite to the reference scan direction in accordance with a speed difference between a target and the vehicle derived from traveling information and traveling environment information about the vehicle, and performs scanning with the irradiation light.

2. An optical ranging device installed in a vehicle, the device comprising:
a light emitter configured to emit irradiation light;
a scanner configured to scan a predefined scan region with the irradiation light;
a light receiver configured to, in response to the scan with the irradiation light, receive light including reflected light of the irradiation light from the scan region, and output an electrical signal corresponding to a reception state of the reflected light; and
a measurer configured to measure a distance to an object within at least the scan region based on the signal output from the light receiver, wherein
when the scan region is defined in front of the vehicle, in a traveling situation in which the vehicle turns, the scanner performs a scan with the irradiation light in a scan direction indicating a direction of the irradiation light from one end of the scan region facing in a turning direction of the vehicle to another end of the scan region facing in a direction opposite to the turning direction.

3. The optical ranging device according to claim 1, wherein
at an end of the scan with the irradiation light in a current scan direction, the scanner changes the scan direction of the irradiation light and starts scanning with the irradiation light in a next scan direction.

4. The optical ranging device according to claim 2, wherein
at an end of the scan with the irradiation light in a current scan direction, the scanner changes the scan direction of the irradiation light and starts scanning with the irradiation light in a next scan direction.

5. A control method for an optical ranging device installed in a vehicle and configured to: scan a predefined scan region with irradiation light; in response to the scan with the irradiation light, receive light including reflected light from the scan region; and measure a distance to an object within at least the scan region based on an electrical signal corresponding to a reception state of the reflected light, the method comprising:
performing scanning with the irradiation light in a reference scan direction indicating a predetermined direction of scanning with the irradiation light, wherein
when the scan region is defined lateral to the vehicle, the reference scan direction on the right and the reference scan direction on the left are opposite to each other, and
the method comprises switching between the reference scan direction and a reverse scan direction opposite to the reference scan direction in accordance with a speed difference between a target and the vehicle derived from traveling information and traveling environment information about the vehicle, and performing scanning with the irradiation light.

6. A control method for an optical ranging device installed in a vehicle and configured to: scan a predefined scan region with irradiation light; in response to the scan with the irradiation light, receive light including reflected light from the scan region; and measure a distance to an object within at least the scan region based on an electrical signal corresponding to a reception state of the reflected light, the method comprising:
when the scan region is defined in front of the vehicle, in a traveling situation in which the vehicle turns, performing a scan with the irradiation light in a scan direction indicating a direction of the irradiation light from one end of the scan region facing in a turning direction of the vehicle to another end of the scan region facing in a direction opposite to the turning direction.
